(19) United States
(12) Patent Application Publication
(10) Pub. No.: US 2023/0333052 A1
(43) Pub. Date: Oct. 19, 2023

(54) REDUNDANT ELECTRODE-BASED ELECTROCHEMICAL SENSOR AND ATTENUATION COMPENSATION METHOD THEREOF

(71) Applicants: Shaoda ZHANG, Guangdong (CN); Xingyu Zheng, Guangdong (CN); Hongyang Cao, Guangdong (CN)

(72) Inventors: Shaoda ZHANG, Guangdong (CN); Xingyu Zheng, Guangdong (CN); Hongyang Cao, Guangdong (CN)

(21) Appl. No.: 17/962,549

(22) Filed: Oct. 10, 2022

(30) Foreign Application Priority Data
Apr. 14, 2022 (CN) 202210387572.4

(51) Int. Cl. G01N 27/416; G01N 27/327

(52) U.S. Cl. CPC G01N 27/4163; G01N 27/3275

(57) ABSTRACT

The present disclosure relates to a redundant electrode-based electrochemical sensor and an attenuation compensation method thereof. The redundant electrode-based electrochemical sensor includes an interface base and a probe portion. The interface base is provided with three electrical connection terminals. The probe portion is provided with a primary electrode sensor and a redundant electrode sensor. The primary electrode sensor and the redundant electrode sensor are respectively provided with a counter electrode, a working electrode, and a reference electrode, and share one counter electrode. The present disclosure realizes that an unknown measurement result of the primary electrode sensor is predicted by means of known characteristics of the redundant electrode sensor, a more accurate correction value is calculated, additional attenuation compensation does not need to be performed, and conventional empirical compensation method and attenuation curve fitting method are abandoned to avoid causing errors.

### BACKGROUND OF THE INVENTION

The present disclosure relates to the field of electrochemical sensors, in particular to a redundant electrode-based electrochemical sensor and an attenuation compensation method thereof.

In general, three-electrode technologies are used for existing electrochemical sensors. The influence of current changes on electrochemical reaction bias is removed by adding reference electrodes. Electrochemical sensors are used in many fields, especially in the medical field with the higher requirements on the sensitivity and output accuracy of sensors, and otherwise medical accidents may be caused or even the lives of patients are endangered.

In the medical field, by taking the measurement of human glucose concentration as an example, although enzyme that mainly controls the sensitivity of a sensor will not decrease with the process of a chemical reaction in theory, the enzyme that effectively participates in the chemical reaction is constantly decreasing in practical application, and its activity will also gradually decrease as the environment changes.

In a traditional method, an empirical compensation value is used or an attenuation curve is actually measured and fitted into a function formula, and then an attenuated part is compensated in actual use to obtain an output result that is as close to a real value as possible. In this way, some problems will be brought about. For example: the empirical compensation value is relatively fixed and cannot reflect subtle differences of sensors in signal output; and the actually measured attenuation curve is nonlinear, and errors are constantly introduced in an empirical value-fitting-compensation regression process, resulting in a certain error between a final result and an actual result.

The above problems are worth solving.

### BRIEF SUMMARY OF THE INVENTION

In order to overcome the deficiencies in the prior art, the present disclosure provides a redundant electrode-based electrochemical sensor and an attenuation compensation method thereof.

A technical solution of the present disclosure is as follows:

A redundant electrode-based electrochemical sensor, including an interface base and a probe portion, the interface base being provided with three electrical connection terminals including a first terminal, a second terminal, and a third terminal; the probe portion being provided with a primary electrode sensor and a redundant electrode sensor, and the redundant electrode sensor being positioned at an outer end of the probe portion; the primary electrode sensor and the redundant electrode sensor being respectively provided with a counter electrode, a working electrode, and a reference electrode, and sharing one counter electrode; and the first terminal being connected to the counter electrode, the second terminal being connected to the working electrode, and the third terminal being connected to the reference electrode.

In the present disclosure according to the above solution, the counter electrode is positioned on a back surface of the probe portion.

In the present disclosure according to the above solution, the counter electrode extends from the primary electrode sensor to the redundant electrode sensor.

In the present disclosure according to the above solution, the working electrode includes a first working electrode of the primary electrode sensor and a second working electrode of the redundant electrode sensor; and the reference electrode includes a first reference electrode of the primary electrode sensor and a second reference electrode of the redundant electrode sensor.

According to another aspect, the present disclosure further provides an attenuation compensation method for a redundant electrode-based electrochemical sensor, including the following steps:
S1: calculating a current response formula for a redundant electrode sensor;
S2: cutting off the redundant electrode sensor to obtain a primary electrode sensor;
S3: measuring a current signal It, a solution temperature T, and working time t of the sensor at a certain time by using the primary electrode sensor; and
S4: predicting a result of the primary electrode sensor by means of characteristics of the redundant electrode sensor.

In the present disclosure according to the above solution, the current response formula for the redundant electrode sensor in Step S1 is Ic = F1(C) * F2(T) * F3(t), where C is the solution concentration, T is the solution temperature, and t is the working time of the sensor.

Further, in Step S1, specific forms and parameters of F1(C), F2(T), and F3(t) obtained by testing and fitting the redundant electrode sensor include:
a concentration function formula F1(C) = k * C + b, where k and b are constants;
a temperature function formula F2(T) = a₂ * T² + a₁ * T + a₀, where a₀, a₁, and a₂ are constants; and
a time function formula F3(t) = log(a₄) / log(t), wherein a₄ is a constant, obtained by fitting after measurement.

In the present disclosure according to the above solution, Step S4 includes:
S401: substituting the parameters measured in Step S3 into the formula It = F1(C) * F2(T) * F3(t), namely,
substituting known variables It, F2(T), and F3(t) into the formula It = F1(C) * F2(T) * F3(t); and
S402: reversely deducing the glucose concentration of a solution where the primary electrode sensor is located, namely,
reversely deducing F1(C) to obtain the glucose concentration C of the solution where the primary electrode sensor is located.

The present disclosure according to the above solution has the following beneficial effects:

In the present disclosure, the primary electrode sensor and the redundant electrode sensor are fabricated on a same substrate and share one counter electrode, which ensures the high similarity between a redundant electrode and a primary electrode; in the present disclosure, the characteristics of the redundant electrode sensor are obtained first, which includes mastering time attenuation performance of the redundant electrode sensor, then the unknown measurement result of the primary electrode sensor is predicted by means of the known characteristics of the redundant electrode sensor, and a more accurate result is calculated; and moreover, additional attenuation compensation does not need to be performed, and conventional empirical compensation method and attenuation curve fitting method are abandoned to avoid causing errors and make the result more accurate.

### BRIEF DESCRIPTION OF THE DRAWINGS

FIG. 1 is a schematic diagram of a front structure of the present disclosure;

FIG. 2 is a schematic diagram of a back structure of the present invention; and

FIG. 3 is a flowchart of a method in the present disclosure.

In which: 1: interface base; 11: first terminal; 12: second terminal; 13: third terminal;

2: probe portion; 21: counter electrode; 221: first working electrode; 222: second working electrode; 231: first reference electrode; and 232: second reference electrode.

### DETAILED DESCRIPTION OF THE INVENTION

In order to better understand the objective, technical solution, and technical effects of the present disclosure, the present disclosure is further described below with reference to the accompanying drawings and the embodiments. At the same time, it is stated that the embodiments described below are only used to explain the present disclosure and are not used to limit the present disclosure.

It should be noted that when an element is referred to as being “fixed to” or “arranged on” another element, it may be directly on another element or an intervening element may also be present. When an element is referred to as being “connected” to another element, it may be directly connected to another element or an intervening element may also be present.

The orientations or positions indicated by the terms “upper”, “lower”, “left”, “right”, “front”, “back”, “vertical”, “horizontal”, “top”, “bottom”, “inner”, “outer”, etc. are based on the orientations or positions shown in the accompanying drawings, only facilitate the description, and should not be construed as a limitation to this technical solution.

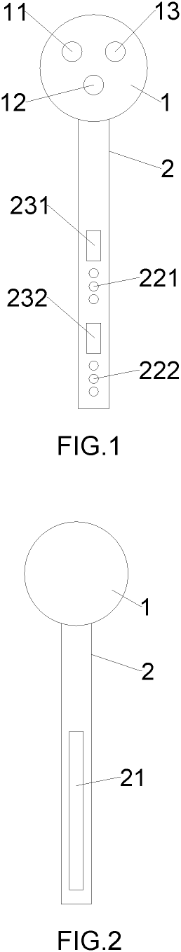

As shown in FIGS. 1 and 2, a redundant electrode-based electrochemical sensor includes an interface base 1 and a probe portion 2. The interface base 1 is provided with three electrical connection terminals that are configured to supply power and output signals to the sensor, and specifically include a first terminal 11, a second terminal 12, and a third terminal 13. For example, the second terminal 12 is configured to supply the power, and the first terminal 11 and the third terminal 13 are configured to output the signals. The probe portion 2 is provided with a counter electrode 21, a working electrode, and a reference electrode for an electrochemical reaction. The first terminal 11 is connected to the counter electrode 21, the second terminal 12 is connected to the working electrode, and the third terminal 13 is connected to the reference electrode. Specifically, the terminals are connected to the electrodes via printed circuits.

The probe portion 2 in the present disclosure is provided with a primary electrode sensor and a redundant electrode sensor. The redundant electrode sensor is positioned at an outer end of the probe portion 2, which facilitates the redundant electrode sensor at the outer end to be cut off during operation.

The primary electrode sensor and the redundant electrode sensor are respectively provided with a counter electrode 21, a working electrode, and a reference electrode, and share one counter electrode 21. The working electrode includes a first working electrode 221 of the primary electrode sensor and a second working electrode 222 of the redundant electrode sensor. The reference electrode includes a first reference electrode 231 of the primary electrode sensor and a second reference electrode 232 of the redundant electrode sensor.

In terms of electrical connection, the first terminal 11 is connected to the shared counter electrode 21, the second terminal 12 is connected to the first working electrode 221 and the second working electrode 222, and the third terminal 13 is connected to the first reference electrode 231 and the second reference electrode 232.

In conclusion, the counter electrode 21, the first working electrode 221, and the first reference electrode 231 constitute the primary electrode sensor on an upper half section of the probe portion 2, and the counter electrode 21, the second working electrode 222, and the second reference electrode 232 constitute the redundant electrode sensor on a lower half section of the probe portion 2.

In the present disclosure, the counter electrode 21 is positioned on a back surface of the probe portion 2, and the two groups of working electrodes and reference electrode are positioned on a front surface of the probe portion 2. Compared with a conventional electrochemical sensor, the length of the counter electrode 21 is increased, and the counter electrode 21 extends from the primary electrode sensor to the redundant electrode sensor. Since the primary electrode sensor and the redundant electrode sensor are fabricated on a same substrate, their characteristics are very similar.

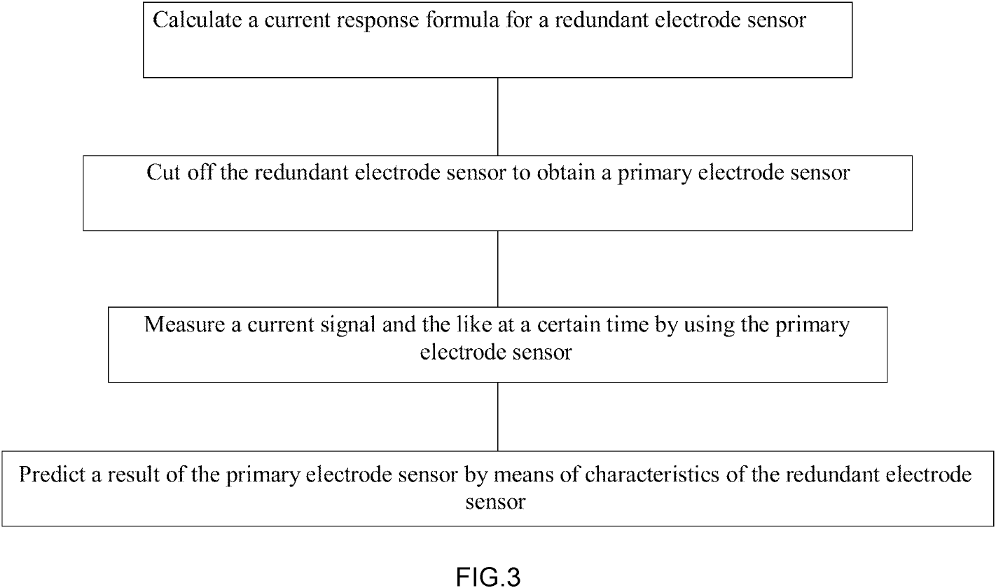

As shown in FIG. 3, the present disclosure further provides an attenuation compensation method for a redundant electrode-based electrochemical sensor, including the following steps:
S1: calculating a current response formula for a redundant electrode sensor;
S2: cutting off the redundant electrode sensor to obtain a primary electrode sensor;
S3: measuring a current signal It, a solution temperature T, and working time t of the sensor at a certain time by using the primary electrode sensor; and
S4: predicting a result of the primary electrode sensor by means of characteristics of the redundant electrode sensor.

In this embodiment, the current response formula for the redundant electrode sensor in Step S1 is Ic = F1(C) * F2(T) * F3(t), where C is the solution concentration, T is the solution temperature, and t is the working time of the sensor. Specifically, specific forms and parameters of F1(C), F2(T), and F3(t) obtained by testing and fitting the redundant electrode sensor include:
a concentration function formula F1(C) = k * C + b, where k and b are constants;
a temperature function formula F2(T) = a₂ * T² + a₁ * T + a₀, where a₀, a₁, and a₂ are constants; and
a time function formula F3(t) = log(a₄) / log(t), where a₄ is a constant, obtained by fitting after measurement.

In this embodiment, Step S4 includes:

S401: substituting the parameters measured in Step S3 into the formula It = F1(C) * F2(T) * F3(t).

Due to the high similarity between a primary electrode and a redundant electrode, the current formula for the primary electrode sensor may be represented by means of the current response formula for the redundant electrode sensor, it is obtained that It = F1(C) * F2(T) * F3(t), and known variables It, F2(T), and F3(t) are substituted into the formula It = F1(C) * F2(T) * F3(t).

S402: reversely deducing the glucose concentration of a solution where the primary electrode sensor is located, namely,

reversely deducing F1(C) to obtain the glucose concentration C of the solution where the primary electrode sensor is located.

The technical features of the above embodiments may be randomly combined. For the sake of brevity, all possible combinations of the technical features in the above embodiments are not described. However, as long as there is no contradiction in the combinations of these technical features, all the combinations are regarded to be within the scope of this specification.

The above-mentioned embodiments only represent several implementations of the present disclosure described more specifically and detailedly, but should not be construed as a limitation to the scope of the patent for the present disclosure. It should be noted that several modifications and improvements that may also be made by those of ordinary skill in the art without departing from the concept of the present disclosure fall within the scope of protection of the present disclosure. Therefore, the scope of protection of the patent for the present disclosure should be subject to the appended claims.

What is claimed is:

1. A redundant electrode-based electrochemical sensor, comprising an interface base and a probe portion, the interface base being provided with three electrical connection terminals comprising a first terminal, a second terminal, and a third terminal;
the probe portion being provided with a primary electrode sensor and a redundant electrode sensor, and the redundant electrode sensor being positioned at an outer end of the probe portion; the primary electrode sensor and the redundant electrode sensor being respectively provided with a counter electrode, a working electrode, and a reference electrode, and sharing one counter electrode; and
the first terminal being connected to the counter electrode, the second terminal being connected to the working electrode, and the third terminal being connected to the reference electrode.

2. The redundant electrode-based electrochemical sensor according to claim 1, wherein the counter electrode is positioned on a back surface of the probe portion.

3. The redundant electrode-based electrochemical sensor according to claim 1, wherein the counter electrode extends from the primary electrode sensor to the redundant electrode sensor.

4. The redundant electrode-based electrochemical sensor according to claim 1, wherein the working electrode comprises a first working electrode of the primary electrode sensor and a second working electrode of the redundant electrode sensor; and the reference electrode comprises a first reference electrode of the primary electrode sensor and a second reference electrode of the redundant electrode sensor.

5. An attenuation compensation method for a redundant electrode-based electrochemical sensor, comprising the following steps:
S1: calculating a current response formula for a redundant electrode sensor;
S2: cutting off the redundant electrode sensor to obtain a primary electrode sensor;
S3: measuring a current signal It, a solution temperature T, and working time t of the sensor at a certain time by using the primary electrode sensor; and
S4: predicting a result of the primary electrode sensor by means of characteristics of the redundant electrode sensor.

6. The attenuation compensation method for a redundant electrode-based electrochemical sensor according to claim 5, wherein the current response formula for the redundant electrode sensor in Step S1 is Ic = F1(C) * F2(T) * F3(t), wherein C is the solution concentration, T is the solution temperature, and t is the working time of the sensor.

7. The attenuation compensation method for a redundant electrode-based electrochemical sensor according to claim 6, wherein in Step S1, specific forms and parameters of F1(C), F2(T), and F3(t) obtained by testing and fitting the redundant electrode sensor comprise:
a concentration function formula F1(C) = k * C + b, wherein k and b are constants;
a temperature function formula F2(T) = a₂ * T² + a₁ * T + a₀, wherein a₀, a₁, and a₂ are constants; and
a time function formula F3(t) = log(a₄) / log(t), wherein a₄ is a constant, obtained by fitting after measurement.

8. The attenuation compensation method for a redundant electrode-based electrochemical sensor according to claim 5, wherein Step S4 comprises:
S401: substituting the parameters measured in Step S3 into the formula It = F1(C) * F2(T) * F3(t), namely,
substituting known variables It, F2(T), and F3(t) into the formula It = F1(C) * F2(T) * F3(t); and
S402: reversely deducing the glucose concentration of a solution where the primary electrode sensor is located, namely,
reversely deducing F1(C) to obtain the glucose concentration C of the solution where the primary electrode sensor is located.
